(19) United States
(12) Patent Application Publication
(10) Pub. No.: US 2026/0259525 A1
(43) Pub. Date: Sep. 3, 2026

(54) DIAGNOSIS APPARATUS, SYSTEM, AND DIAGNOSIS METHOD

(71) Applicant: SEIKO EPSON CORPORATION, Tokyo (JP)

(72) Inventors: Yasuo SUNAGA, Matsumoto (JP); Kazuki YOSHIDA, Fujimi-machi (JP)

(21) Appl. No.: 19/550,382

(22) Filed: Feb. 26, 2026

(30) Foreign Application Priority Data
Feb. 28, 2025 (JP) 2025-030946

(51) Int. Cl. G03G 15/00; H04N 1/00

(52) U.S. Cl. CPC G03G 15/757; G03G 15/55; H04N 1/00039

(57) ABSTRACT

A diagnosis apparatus includes: an acquiring section that acquires a transport speed of a medium in a transport apparatus that transports the medium to a printing section; a storage section that stores the acquired transport speed; and a determining section that performs time-series analysis on the stored transport speed and determines, based on a timing at which a change in the transport speed has occurred, a location where an abnormality has occurred in the transport of the medium.

The present application is based on, and claims priority from JP Application Serial Number 2025-030946, filed February 28, 2025, the disclosure of which is hereby incorporated by reference herein in its entirety.

### BACKGROUND

### 1. Technical Field

The present disclosure relates to a diagnosis apparatus, a system, and a diagnosis method.

### 2. Related Art

In the related art, there is an apparatus which diagnoses a failure, such as banding, related to a transport apparatus that transports recording paper (hereinafter, referred to as a sheet) in a printer or the like. JP-A-2019-78916 discloses an image forming apparatus that estimates transport intervals at which a plurality of sheets are transported, and estimates a component corresponding to a specific periodicity as a failure location when the image forming apparatus determines that the specific periodicity is present based on the estimated transport intervals and a position of an image abnormality detected from each sheet. JP-A-2014-16437 discloses a failure location determination apparatus that reads an output image from an image forming apparatus and determines a failure location based on a feature quantity of an image defect in the read image.

In the above-described related art, it is necessary to form an image on a sheet by the image forming apparatus and to read the formed image in order to perform failure diagnosis, and further improvement in the failure diagnosis has been desired.

### SUMMARY

According to an aspect of the present disclosure, there is provided a diagnosis apparatus including: an acquiring section that acquires a transport speed of a medium in a transport apparatus that transports the medium to a printing section; a storage section that stores the acquired transport speed; and a determining section that performs time-series analysis on the stored transport speed and determines, based on a timing at which a change in the transport speed has occurred, a location where an abnormality has occurred in the transport of the medium.

According to another aspect of the present disclosure, there is provided a system in which a transport apparatus that transports a medium to a printing section and a diagnosis apparatus are communicably coupled to each other via a network, wherein the diagnosis apparatus includes an acquiring section that acquires a transport speed of the medium in the transport apparatus that transports the medium to the printing section, a storage section that stores the acquired transport speed, and a determining section that performs time-series analysis on the stored transport speed and determines, based on a timing at which a change in the transport speed has occurred, a location where an abnormality has occurred in the transport of the medium.

According to still another aspect of the present disclosure, there is provided a diagnosis method including causing a computer to execute processing of: acquiring a transport speed of a medium in a transport apparatus that transports the medium to a printing section; storing the acquired transport speed in a storage section; and performing time-series analysis on the stored transport speed and determining, based on a timing at which a change in the transport speed has occurred, a location where an abnormality has occurred in the transport of the medium.

### BRIEF DESCRIPTION OF THE DRAWINGS

FIG. 1 is a diagram illustrating an example of a system according to an embodiment.

FIG. 2 is a diagram illustrating an example of a functional configuration of a printer.

FIG. 3 is a schematic diagram illustrating a printing mechanism.

FIG. 4 is a diagram illustrating an example of a functional configuration of a server apparatus.

FIG. 5 is a diagram illustrating an example of a change in a transport speed of a sheet.

FIG. 6 is a diagram illustrating an example of measurement data.

FIGS. 7A and 7B are flowcharts illustrating an example of an operation of the server apparatus.

FIG. 8 is a diagram illustrating an outline of PTS correction.

### DESCRIPTION OF EMBODIMENTS

Hereinafter, embodiments of the present disclosure will be described in detail with reference to the drawings. However, unnecessarily detailed description may be omitted. For example, detailed description of well-known matters or redundant description of a substantially identical configuration may be omitted.

In the description of the present disclosure, general abbreviations may be used for description. For example, LAN is an abbreviation for Local Area Network. CPU is an abbreviation for Central Processing Unit. MPU is an abbreviation of Micro-Processing Unit. PC is an abbreviation for Personal Computer. ROM is an abbreviation for Read-Only Memory. RAM is an abbreviation for Random-Access Memory. HDD is an abbreviation of Hard Disk Drive. SSD is an abbreviation for Solid-State Drive. SoC is an abbreviation for System-on-a-Chip. DSP is an abbreviation for Digital Signal Processor. PTS is an abbreviation for Pulse Timing Signal. LSI is an abbreviation of Large Scale Integration. ASIC is an abbreviation for Application-Specific Integrated Circuit. PLD is an abbreviation for Programmable Logic Device. FPGA is an abbreviation of Field-Programmable Gate Array. USB is an abbreviation for Universal Serial Bus.

In the description of the present disclosure, components having the same or having similar functions may be distinguished from each other by adding alphanumeric characters or the like to the ends of reference signs. In addition, in the description of the present embodiment, a plurality of components having the same or similar functions may be described without distinction by omitting alphanumeric characters or the like at the ends of reference signs.

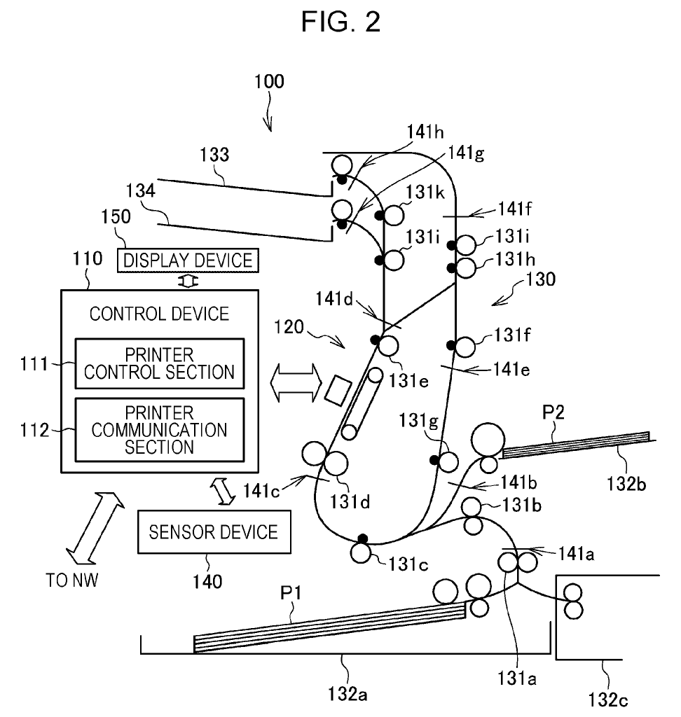

For example, in FIG. 2, when transport rollers 131a to 131k are not particularly distinguished from each other, the transport rollers 131a to 131k are referred to as transport rollers 131. Similarly, when sensors 141a to 141k are not particularly distinguished from each other, the sensors 141a to 141k are referred to as sensors 141. In addition, when sheets P1 and P2 are not particularly distinguished from each other, the sheets P1 and P2 are referred to as sheets P.

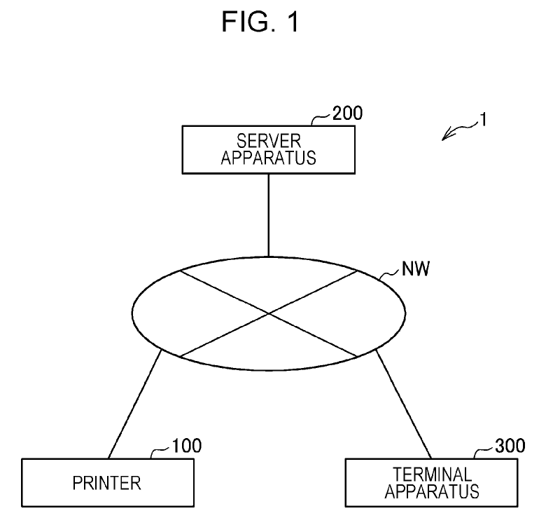

FIG. 1 is a diagram illustrating an example of a system according to an embodiment. As illustrated in FIG. 1, a system 1 includes a printer 100, a server apparatus 200, and a terminal apparatus 300. The printer 100, the server apparatus 200, and the terminal apparatus 300 are communicably coupled to each other via a network NW. The network NW is, for example, the Internet, a LAN, or the like.

The printer 100 includes a transport mechanism that transports a sheet, and a printing mechanism that performs printing on the transported sheet by a predetermined printing method such as an electrophotographic method or an ink jet method. The printer 100 is an example of a transport apparatus that transports a sheet that is an example of a medium. The transport apparatus may be incorporated as the transport mechanism in the printer 100 or may be an independent apparatus separated from the printer 100. In addition, the medium is not limited to the sheet, and may be, for example, cloth or the like.

FIG. 2 is a diagram illustrating an example of a functional configuration of the printer 100. As illustrated in FIG. 2, the printer 100 includes a control device 110, a printing mechanism 120, a transport mechanism 130, a sensor device 140, and a display device 150.

The control device 110 is a processor such as a CPU or an MPU and executes a program. The control device 110 provides functions as a printer control section 111 and a printer communication section 112 by, for example, the CPU executing the program.

The printer control section 111 is a processing section that controls an operation of the printer 100. The printer control section 111 performs printing on a sheet P by driving the transport mechanism 130 and the printing mechanism 120 based on, for example, a print request from the server apparatus 200, the terminal apparatus 300, or the like coupled via the network NW.

Specifically, when receiving the print request, the printer control section 111 drives a predetermined transport roller 131 of the transport mechanism 130 and causes the printing mechanism 120 to transport the sheets P1 and P2 mounted on sheet feed cassettes 132a and 132c and a sheet feed tray 132b. Next, the printer control section 111 performs, based on printing conditions included in the print request, printing on the transported sheets P1 and P2 by the printing mechanism 120. Next, the printer control section 111 drives the predetermined transport roller 131 of the transport mechanism 130 so as to transport the printed sheets P1 and P2 to a first sheet ejection tray 133 or a second sheet ejection tray 134.

The printer communication section 112 is a processing section that performs communication with external apparatuses such as the server apparatus 200 and the terminal apparatus 300 coupled via the network NW. Specifically, the printer communication section 112 receives various requests and instructions such as the print request from the server apparatus 200 or the terminal apparatus 300. The printer communication section 112 makes a response in response to a request from the server apparatus 200 or the terminal apparatus 300.

For example, in a case where a request for acquiring measurement data measured by the sensor device 140 is issued by the server apparatus 200 or the terminal apparatus 300, the printer communication section 112 transmits the measurement data to the request source together with identification information indicating a sensor from which the measurement data is acquired.

The printing mechanism 120 performs printing on the sheets P transported by the transport mechanism 130 by a predetermined printing method such as an electrophotographic method or an ink jet method under control by the printer control section 111.

The transport mechanism 130 includes the sheet feed cassettes 132a and 132c and the sheet feed tray 132b on which the sheets P1 and P2 are mounted, and the transport rollers 131 that transport the sheets P1 and P2.

Specifically, the transport rollers 131a to 131d transport the sheets P1 and P2 mounted on the sheet feed cassettes 132a and 132c or the sheet feed tray 132b to the printing mechanism 120.

The transport rollers 131e to 131k transport the sheets P1 and P2 printed by the printing mechanism 120 from the printing mechanism 120 to the first sheet ejection tray 133 or the second sheet ejection tray 134. The transport rollers 131e to 131k reverse front and rear surfaces of the sheets P1 and P2 printed by the printing mechanism 120 and transport the sheets P1 and P2 to the printing mechanism 120 again. The transport of the sheets P in the printing mechanism 120 by the transport mechanism 130 will be described in detail later.

The sensor device 140 is a sensor that detects various states of the printer 100, and includes, for example, a temperature and humidity sensor that detects the temperature and humidity of the printer 100. In addition, the sensor device 140 includes the sensor 141 for detecting a sheet P at a predetermined transport position on a transport path through which the sheet P is transported.

For example, the sensor 141 is an optical sensor that detects the sheet P that has passed above the sensor. In addition, the sensors 141a to 141h are disposed at predetermined transport positions such as an entrance and an exit of the printing mechanism 120 on the transport path from the feeding of the sheet P through the printing in the printing mechanism 120 to the ejection of the sheet P. Details of the sensor device 140 that performs detection for the transport of the sheet P in the printing mechanism 120 will be described later.

The display device 150 is a display that displays various types of information under control by the control device 110. For example, the display device 150 displays various statuses during printing on the sheet P by the printer control section 111. In addition, the display device 150 displays various notifications received by the printer communication section 112 from the server apparatus 200, the terminal apparatus 300, and the like coupled via the network NW.

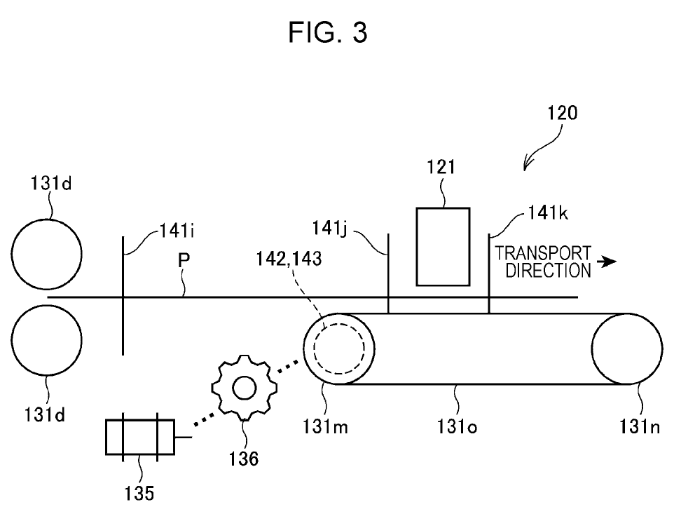

An outline of the printing mechanism 120 will be described. FIG. 3 is a schematic diagram illustrating the printing mechanism 120. As illustrated in FIG. 3, the printing mechanism 120 includes a printing section 121 that performs printing on the sheet P transported by the transport mechanism 130 under control by the printer control section 111. In the present embodiment, as an example, the printing section 121 performs printing on the sheet P by the ink jet method.

The printer control section 111 operates the printing section 121 so as to eject ink at a predetermined timing based on the transport position of the sheet P detected by the sensor device 140 and a transport speed that has been detected by the sensor device 140 and at which the sheet P is transported, and forms an image on the sheet P.

The transport mechanism 130 that transports the sheet P transported by the transport roller 131d to the printing section 121 includes transport rollers 131m and 131n, a transport belt 131o, a motor 135, and a gear 136. The transport mechanism 130 that includes the transport rollers 131m and 131n, the transport belt 131o, the motor 135, and the gear 136 is an example of a transport apparatus. The transport rollers 131m and 131n, the transport belt 131o, the motor 135, and the gear 136 are examples of drive components that are disposed for transport of the sheet P. For example, the transport roller 131m is a first drive component to be subjected to detection by an encoder 142 for acquisition of the transport speed of the sheet P. Each of the transport roller 131n, the transport belt 131o, the motor 135, and the gear 136 other than the transport roller 131m is a second drive component that is disposed for transport of the sheet P.

The ring-shaped wide transport belt 131o is wound around the transport roller 131m disposed near the entrance of the printing mechanism 120 and the transport roller 131n disposed near the exit of the printing mechanism 120. The transport rollers 131m and 131n are rotationally driven by a driving force of the motor 135 driven under control by the printer control section 111. Specifically, the transport roller 131m is rotationally driven via the gear 136 that transmits the driving force of the motor 135 to the transport roller 131m. By the rotational driving of the transport roller 131m, the transport belt 131o is moved in a transport direction and the transport roller 131n is rotationally driven.

The sheet P on the transport belt 131o is transported from the entrance of the printing mechanism 120 toward the exit of the printing mechanism 120 through the printing section 121 by the movement of the transport belt 131o caused by the rotational driving of the transport rollers 131m and 131n.

The sensors 141i, 141j, and 141k, the encoder 142, and a scale 143 are disposed as the sensor device 140 that performs detection for the transport of the sheet P in the printing mechanism 120.

The sensors 141i, 141j, and 141k detect the sheet P at a predetermined transport position such as the entrance of the printing mechanism 120 or the front and rear of the printing section 121. The encoder 142 is a rotary encoder in which the circular scale 143 that interlocks with a rotation shaft of the transport roller 131m is incorporated. The encoder 142 detects an amount and an angle of the rotation of the transport roller 131m. That is, the encoder 142 is an example of a sensor for acquisition of the transport speed of the sheet P transported in accordance with the rotation of the transport roller 131m.

Returning to FIG. 1, the server apparatus 200 manages the operation of the printer 100. For example, the server apparatus 200 receives, from the terminal apparatus 300, a print instruction including text data, image data, a sheet size, a surface to be printed, and the like regarding printing by the printer 100. Based on the print instruction from the terminal apparatus 300, the server apparatus 200 issues a print request to transport sheets P1 and P2 of a predetermined size and perform printing on the surface instructed to be printed. Next, the server apparatus 200 notifies the printer 100 of the issued print request, and causes the printer 100 to perform the printing corresponding to the print instruction from the terminal apparatus 300.

Next, the server apparatus 200 performs notification to the terminal apparatus 300 based on data obtained from the printer 100 after the notification of the print request. For example, when a notification indicating that the printing has been completed in accordance with the print request is provided from the printer 100, the server apparatus 200 notifies the terminal apparatus 300 of the completion of the printing.

In addition, the server apparatus 200 acquires measurement data measured by the sensor device 140 during the execution of printing. Next, the server apparatus 200 determines, based on the acquired measurement data, a location where an abnormality has occurred in the transport of the sheet P during the printing, and notifies the printer 100 or the terminal apparatus 300 of the result of the determination. That is, the server apparatus 200 is an example of a diagnosis apparatus.

The terminal apparatus 300 is a computer apparatus that is used by a user, and is, for example, a PC, a smartphone, or the like.

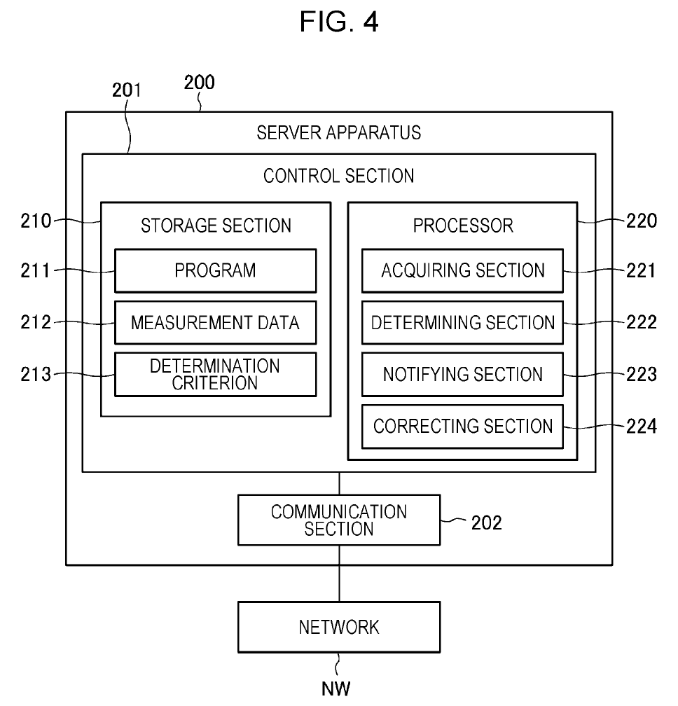

FIG. 4 is a diagram illustrating an example of a functional configuration of the server apparatus 200. As illustrated in FIG. 4, the server apparatus 200 includes a control section 201 and a communication section 202.

The control section 201 includes a storage section 210 and a processor 220. The storage section 210 includes, for example, a nonvolatile memory such as a ROM and a volatile memory such as a RAM. The storage section 210 may include an auxiliary storage device such as an HDD or an SSD.

The storage section 210 stores a program 211 for controlling an operation of each section of the server apparatus 200, measurement data 212, and a determination criterion 213 in the nonvolatile memory or the auxiliary storage device. Further, the volatile memory of the storage section 210 is used as a work area when the processor 220 executes the program 211.

The measurement data 212 is data measured by the sensor device 140 of the printer 100. Specifically, the measurement data 212 includes a measured value together with a measurement date and time. For example, the measurement data 212 includes the temperature, humidity, and the like of the printer 100 measured by the sensor device 140 together with a measurement date and time.

In addition, the measurement data 212 includes data measured by the sensor device 140 together with a measurement date and time every time printing is performed on a sheet P. For example, the measurement data 212 includes values output by the sensors 141i to 141k in the printing mechanism 120 and the transport speed of a sheet P based on a value detected by the encoder 142 every time printing is performed on the sheet P.

The determination criterion 213 includes a determination criterion for determining an error or the like related to the transport of the sheet P. For example, the determination criterion 213 includes information serving as a criterion for determining, based on the transport speed of the sheet P, a location where an abnormality has occurred in the transport of the sheet P. Details of the information serving as the criterion for determining a location where an abnormality has occurred will be described later.

The processor 220 is an arithmetic processing device such as a CPU or an MPU. The processor 220 may be constituted by a single arithmetic processing device or may be constituted by a plurality of arithmetic processing devices. In addition, the processor 220 may be constituted by a portion or all of the storage section 210 or by an SoC integrated with other circuits. In addition, the processor 220 may be constituted by a combination of a CPU that executes the program 211 and a DSP that executes predetermined arithmetic processing. Further, all of functions of the processor 220 may be implemented by hardware or may be configured using a programmable device. The communication section 202 is a communication interface that communicates with the external apparatuses via the network NW.

The processor 220 provides functions as an acquiring section 221, a determining section 222, a notifying section 223, and a correcting section 224 by reading the program 211 from the storage section 210 and sequentially executing the program.

The acquiring section 221 is a processing section that acquires the measurement data 212 measured by the sensor device 140 from the printer 100. Specifically, the acquiring section 221 acquires the measurement data 212 measured by the sensor device 140 during the transport and printing of the sheet P in the printer 100. Next, the acquiring section 221 stores the acquired measurement data 212 into the storage section 210 together with a recording date and time.

For example, the acquiring section 221 requests the printer 100 to provide data measured by the sensor device 140 during printing on a sheet P. Therefore, the acquiring section 221 acquires the measurement data 212 measured by the sensor device 140 every time printing is performed on a sheet P. The measurement data 212 acquired by the acquiring section 221 includes the transport speed of the sheet P based on values output by the sensors 141i to 141k in the printing mechanism 120 and a value detected by the encoder 142 in a period of time when printing is performed on the sheet P.

The determining section 222 is a processing section that determines a location where an abnormality has occurred in the transport of the sheet P in the printer 100, based on time-series analysis performed on the measurement data 212 stored in the storage section 210.

Specifically, the determining section 222 performs time-series analysis on the transport speed of the sheet P measured during the printing on the sheet P and included in the measurement data 212. The determining section 222 determines a location where an abnormality has occurred in the transport of the sheet P, based on the timing at which a change in the transport speed of the sheet P has occurred and that has been obtained by the time-series analysis.

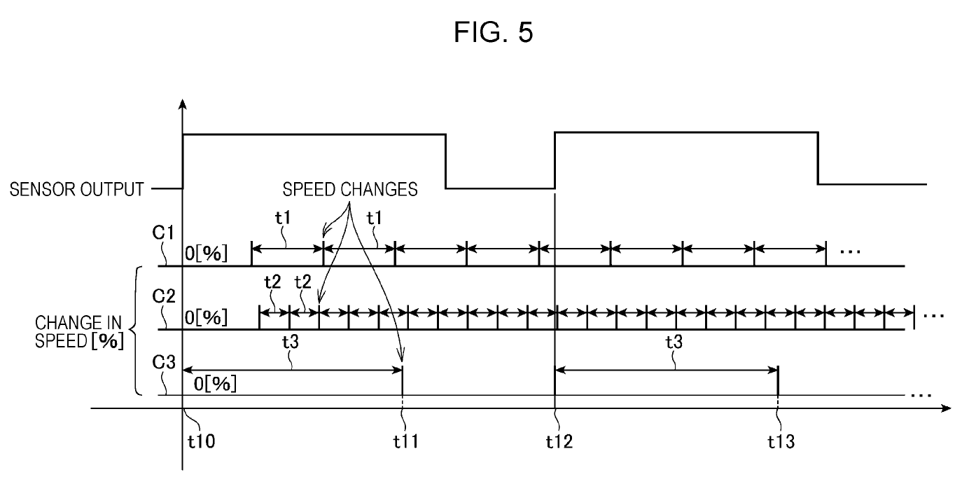

FIG. 5 is a diagram illustrating an example of the change in the transport speed of a sheet P. In FIG. 5, the horizontal axis represents time. In addition, the vertical axis represents an output of the sensor 141 at a predetermined transport position and a change in the transport speed of the sheet P for each of the cases C1 to C3.

For example, the sensor output is a value output from the sensor 141i disposed near the entrance of the printing mechanism 120. As indicated by the sensor output, a period of time from time t10 when a sheet P transported first is detected to time t12 when a sheet P transported next is detected corresponds to a period of time when printing is performed on the sheet P transported first.

The case C1 indicates a change in the transport speed of the sheet P in a case where a location where an abnormality has occurred in the transport of the sheet P is the encoder 142. For example, the case C1 may be a case where dust or the like adheres to a portion of the scale 143 of the encoder 142.

The case C2 indicates a change in the transport speed of the sheet P in a case where a location where an abnormality has occurred in the transport of the sheet P is the gear 136 for driving of the transport roller 131m. For example, the case C2 may be a case where partial meshing failure of the gear 136 has occurred.

The case C3 indicates a change in the transport speed of the sheet P in a case where a location where an abnormality has occurred in the transport of the sheet P is the transport rollers 131m and 131n. For example, the case C3 may be a case where a load applied to the transport rollers 131m and 131n changes during the transport of the sheet P due to slipping out of the sheet P from the transport path or the like.

As illustrated in FIG. 5, in a period of time when printing is performed on one sheet P, the timing at which the transport speed of the sheet P changes differs for each location where an abnormality has occurred in the transport of the sheet P.

For example, in the case C1 where the location where the abnormality has occurred is the encoder 142, the timing at which the transport speed changes is a period t1 corresponding to the scale 143.

Further, in the case C2 where the location where the abnormality has occurred is the gear 136, the timing at which the transport speed changes is a period t2 corresponding to the rotation of the gear 136.

In addition, in the case C3 where the location where the abnormality has occurred is the transport rollers 131m and 131n, the timing at which the transport speed changes is time t11 and time t13 at which the sheet P is transported to a predetermined position where the sheet P is slipped out after time t10 and t12 at which the transport of the sheet P is started. The predetermined position where the sheet P is slipped out is synchronized with the positions of the transport rollers 131m and 131n relative to the position of the sheet P where the transport of the sheet P is started. That is, in the case C3, the timing at which the transport speed changes is a transport period t3 for the transport to the predetermined position where the sheet P is slipped out, according to the transport speed.

In the determination criterion 213, information that differs for each location where an abnormality has occurred in the transport of the sheet P and that is regarding the timing at which a change in the transport speed of the sheet P has occurred is set in advance. The determining section 222 refers to the information set in the determination criterion 213, and determines a location where an abnormality has occurred in the transport of the sheet P, based on the timing at which a change in the transport speed of the sheet P has occurred.

In addition, a change in the transport speed of the sheet P in a case where an abnormality has occurred in the transport of the sheet P is sudden in a case where the abnormality is caused by ink contamination, damage, or the like, and is gradual in a case where the abnormality is caused by a change over time.

The determining section 222 determines the cause of the abnormality at the location where the abnormality has occurred by determining whether the change in the transport speed of the sheet P is sudden based on the tendency of a change in the transport speed of the sheet P as described above.

For example, the determining section 222 arranges past measurement data 212 in chronological order, and obtains the tendency of a change in the transport speed of the sheet P. As an example, the determining section 222 obtains a slope of a change in the transport speed of the sheet P from the past measurement data 212. The determining section 222 determines a threshold value for determining whether a sudden change has occurred, based on the tendency of a change in the transport speed of the sheet P.

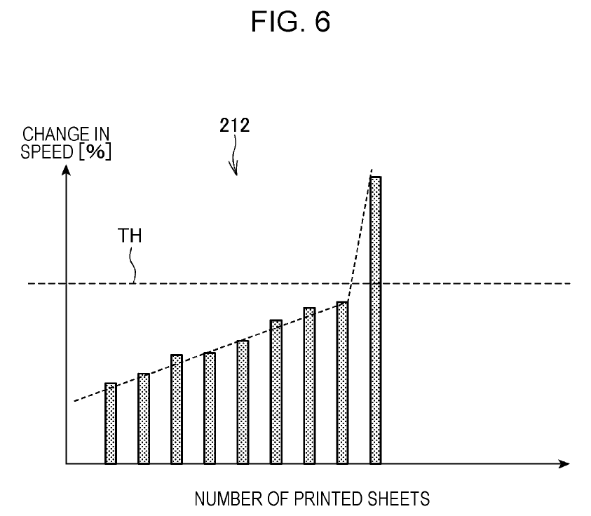

FIG. 6 is a diagram illustrating an example of the measurement data 212. As illustrated in FIG. 6, the determining section 222 arranges changes in the transport speed of the sheet P included in the past measurement data 212 in chronological order. Next, the determining section 222 determines a threshold value TH for determining that a change in the transport speed of the sheet P is sudden when the change is, for example, greater than or equal to +30% or less than or equal to -30% relative to a slope of a past change in the transport speed of the sheet P.

The determining section 222 determines, based on the threshold value TH, a cause of an abnormality at a location where the abnormality has occurred in the transport of the sheet P. Specifically, as in the illustrated example, when a change in the transport speed of the sheet exceeds the threshold value TH, the determining section 222 determines that the change is sudden in comparison with the past tendency.

Referring back to FIG. 4, the notifying section 223 is a processing section that notifies a message corresponding to a result of the determination by the determining section 222. For example, the notifying section 223 notifies the printer 100 or the terminal apparatus 300 of a message corresponding to the result of the determination by the determining section 222. As a result, a user of the printer 100 or the terminal apparatus 300 can recognize the result of the determination by the determining section 222. Details of the message corresponding to the result of the determination by the determining section 222 will be described later.

The correcting section 224 is a processing section that corrects the timing of printing on the sheet P in the printing section 121 of the printer 100. Specifically, the correcting section 224 corrects a PTS that defines the printing timing of the printing section 121 and is notified to the printing section 121 by the printer control section 111 based on a result of detection by the sensor device 140. Details of the PTS correction by the correcting section 224 will be described later.

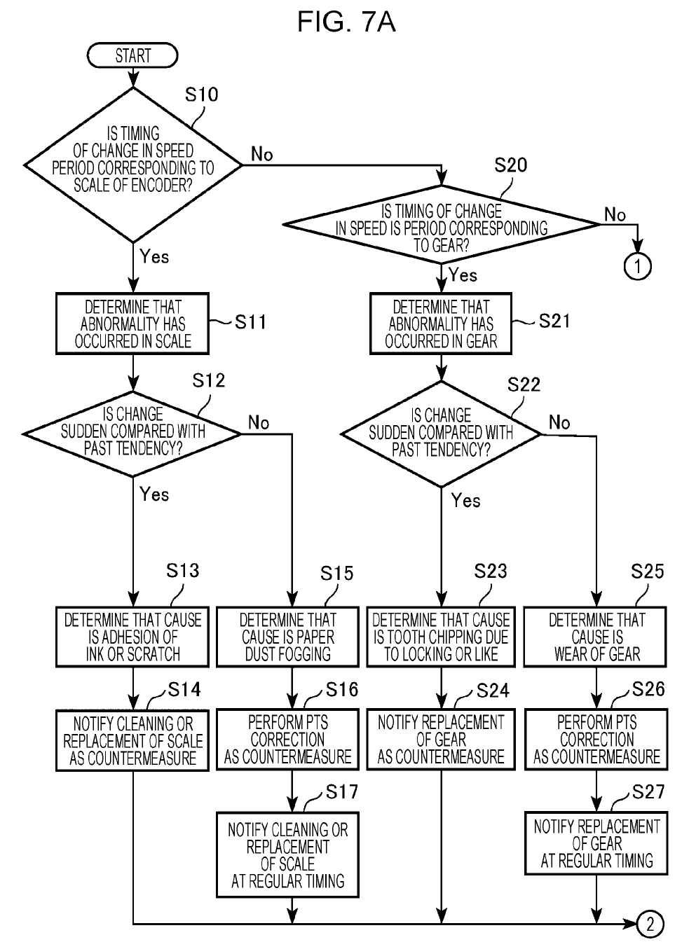

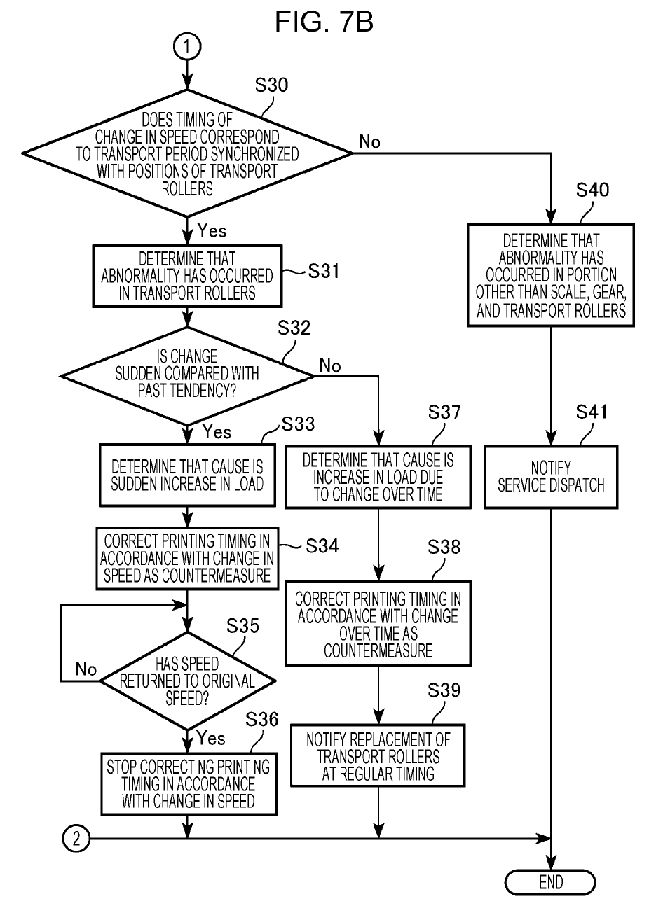

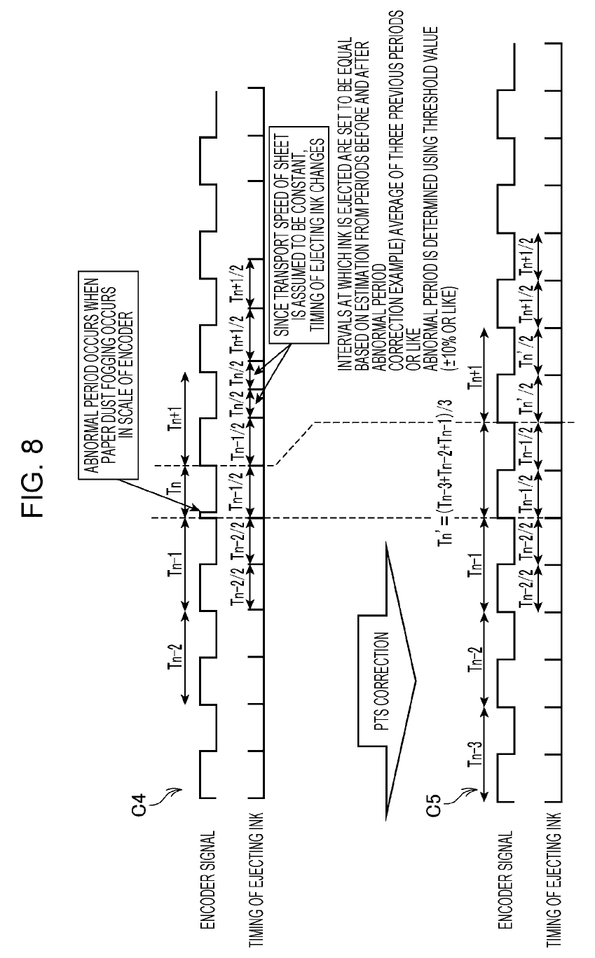

Next, details of a process in the server apparatus 200 will be described with reference to FIGS. 7A, 7B, and 8. FIGS. 7A and 7B are flowcharts illustrating an example of an operation of the server apparatus 200. FIG. 8 is a diagram illustrating an outline of the PTS correction.

As illustrated in FIG. 7A, when the process is started, the determining section 222 performs time-series analysis on the transport speed of the sheet P included in the measurement data 212, and obtains a change in the transport speed in a period of time when printing is performed on the sheet P. Next, the determining section 222 determines whether the timing of the change in the transport speed is the period t1 corresponding to the scale 143 of the encoder 142 (S10).

If the timing of the change in the transport speed is the period t1 (S10: Yes), the determining section 222 determines that an abnormality has occurred in the scale 143 (S11). Next, the determining section 222 compares the change in the transport speed with the past tendency and determines whether the change is sudden (S12).

If the change is sudden (S12: Yes), the determining section 222 determines that the cause of the change is adhesion of ink to the scale 143 or a scratch on the scale 143 (S13). The notifying section 223 notifies a message indicating the abnormality of the scale 143 and a countermeasure against the abnormality based on the result of the determination by the determining section 222 in S13 (S14). Specifically, the notifying section 223 notifies cleaning or replacement of the scale 143 as a countermeasure against the abnormality of the scale 143.

If the change is not sudden (S12: No), the determining section 222 determines that the cause of the change is paper dust fogging on the scale 143 over time (S15). The paper dust is an example of powder, and may be dust other than the paper dust.

In a case where the change is not sudden, the change in the transport speed is small enough to be eliminated by the PTS correction. Therefore, as a countermeasure in a case where the change is not sudden, the correcting section 224 performs the PTS correction for eliminating the change in the transport speed (S16).

A case C4 in FIG. 8 indicates a signal of the encoder 142 and the timing of ejecting ink by the printing section 121 in a case where paper dust is present on the scale 143. A case C5 in FIG. 8 indicates a signal of the encoder 142 after the PTS correction and the timing of ejecting ink by the printing section 121. Each of the signals of the encoder 142 is an example of a value detected by the sensor.

As indicated by the case C4 in FIG. 8, in a case where paper dust is present on the scale 143, an abnormality occurs in a signal provided from the encoder 142 only for a slit portion to which the paper dust adheres. Therefore, the correcting section 224 performs the PTS correction based on a statistic of the signal of the encoder 142 such that the signal corresponding to the slit portion to which the paper dust adheres becomes identical to other signals.

For example, the correcting section 224 calculates an average of three previous periods so as to correct the signal of the encoder 142 and make the signal corresponding to the slit portion to which the paper dust adheres identical to the other signals.

Next, the notifying section 223 notifies cleaning or replacement of the scale 143 as a countermeasure against the abnormality of the scale 143 at a regular timing based on the result of the determination by the determining section 222 in S15 (S17).

If the timing of the change in the transport speed is not the period t1 (S10: No), the determining section 222 determines whether the timing of the change in the transport speed is the period t2 corresponding to the gear 136 (S20).

If the timing of the change in the transport speed is the period t2 (S20: Yes), the determining section 222 determines that an abnormality has occurred in the gear 136 (S21). Next, the determining section 222 compares the change in the transport speed with the past tendency and determines whether the change is sudden (S22).

If the change is sudden (S22: Yes), the determining section 222 determines that the cause of the change is tooth chipping of the gear 136 due to locking or the like (S23). The notifying section 223 notifies a message indicating the abnormality of the gear 136 and a countermeasure against the abnormality based on the result of the determination by the determining section 222 in S23 (S24). Specifically, the notifying section 223 notifies replacement of the gear 136 as a countermeasure against the abnormality of the gear 136.

If the change is not sudden (S22: No), the determining section 222 determines that the cause of the change is wear of the gear 136 over time (S25).

In this case, since the gear 136 has been worn over time, the change in the transport speed is small enough to be eliminated by the PTS correction. Therefore, as a countermeasure against the wear of the gear 136 over time, the correcting section 224 performs the PTS correction for eliminating the change in the transport speed in the same manner as S16 (S26).

Next, the notifying section 223 notifies replacement of the gear 136 as a countermeasure against the abnormality of the gear 136 at a regular timing based on the result of the determination by the determining section 222 in S25 (S27).

If the timing of the change in the transport speed is not the period t2 (S20: No), the determining section 222 determines whether the timing of the change in the transport speed corresponds to the transport period t3 synchronized with the positions of the transport rollers 131m and 131n (S30).

If the timing of the change in the transport speed corresponds to the transport period t3 (S30: Yes), the determining section 222 determines that an abnormality has occurred in the transport rollers 131m and 131n (S31). Next, the determining section 222 compares the change in the transport speed with the past tendency and determines whether the change is sudden (S32).

If the change is sudden (S32: Yes), the determining section 222 determines that the cause of the change in the transport speed is a sudden increase in the load (S33). As a countermeasure against the sudden increase in the load, the correcting section 224 corrects the printing timing in accordance with the change in the transport speed (S34). Specifically, the printing timing is corrected so as to be advanced or delayed in accordance with the magnitude of the change in the transport speed of the sheet P.

Next, the correcting section 224 determines whether the transport speed of the sheet P has returned to the original speed, that is, the speed before the change (S35). If the transport speed of the sheet P has not returned to the original speed (S35: No), the correcting section 224 waits for processing and continues the correction.

If the transport speed of the sheet P has returned to the original speed (S35: Yes), the correcting section 224 stops correcting the printing timing in accordance with the change in the transport speed of the sheet P (S36).

If the change is not sudden (S32: No), the determining section 222 determines that the cause of the change in the transport speed is an increase in the load due to a change in the transport rollers 131m and 131n over time (S37). As a countermeasure against the increase in the load due to the change in the transport rollers 131m and 131n over time, the correcting section 224 corrects the printing timing in accordance with the change in the transport speed due to the change over time (S38). Specifically, the printing timing is corrected so as to be advanced or delayed in accordance with the magnitude of the change in the transport speed of the sheet P due to the change over time.

Next, based on the result of the determination by the determining section 222 in S37, the notifying section 223 notifies, at a regular timing, replacement of the transport rollers 131m and 131n that have changed over time (S39).

If the timing of the change in the transport speed does not correspond to the transport period t3 (S30: No), the determining section 222 determines that an abnormality has occurred in a portion other than the scale 143, the gear 136, and the transport rollers 131m and 131n (S40). The notifying section 223 notifies that the abnormality has occurred in the portion other than the scale 143, the gear 136, and the transport rollers 131m and 131n, based on the result of the determination by the determining section 222 in S40 (S41). As an example, the notifying section 223 notifies service dispatch for handling the abnormality.

As described above, the server apparatus 200 includes the acquiring section 221, the storage section 210, and the determining section 222. The acquiring section 221 acquires the transport speed of the sheet P in the transport mechanism 130 that transports the sheet P to the printing section 121. The storage section 210 stores the transport speed of the sheet P acquired by the acquiring section 221. The determining section 222 performs time-series analysis on the transport speed stored in the storage section 210, and determines, based on the timing at which a change in the transport speed has occurred, a location where an abnormality has occurred in the transport of the sheet P.

Therefore, in the system 1, it is not necessary to form an image on the sheet P, read the sheet P with the image formed, or the like in order to perform failure diagnosis on the printer 100, and it is possible to easily perform the failure diagnosis.

In addition, the determining section 222 determines a location where an abnormality has occurred in the transport of the sheet P, based on the periods t1 and t2 that are the timing at which the changes in the transport speed of the sheet P have occurred.

Therefore, in the system 1, it is possible to identify a characteristic abnormal location at the timing at which a change in the transport speed of the sheet P has occurred.

In addition, the determining section 222 determines a location where an abnormality has occurred in a component among the gear 136, the transport roller 131n, and the like that are driven together with the transport roller 131m to be subjected to detection by the encoder 142 for acquisition of the transport speed of the sheet P and that are disposed for transport of the sheet P.

Therefore, in the system 1, it is possible to identify a location where an abnormality has occurred in a component among not only the transport roller 131m to be subjected to detection by the encoder 142 for acquisition of the transport speed of the sheet P but also the gear 136, the transport roller 131n, and the like that are disposed for transport of the sheet P.

In addition, the encoder 142 detects the rotation of the transport roller 131m based on the scale 143 disposed in the transport roller 131m that transports the sheet P. In a case where a period of the timing at which a change in the transport speed has occurred is the period t1 corresponding to the interval of the scale 143, the determining section 222 determines that a location where an abnormality has occurred is the scale 143 of the encoder 142.

As a result, in the system 1, it is possible to identify that the location where the abnormality has occurred in the transport of the sheet P is the scale 143.

In a case where the period of the timing at which the change in the transport speed has occurred is the period t1 and the change in the transport speed exceeds the threshold value TH, the determining section 222 determines that the change is sudden. Then, in a case where the change is sudden, the determining section 222 determines that the cause of the abnormality is adhesion of ink to the scale 143 or a scratch on the scale 143.

As a result, in the system 1, it is possible to identify that the cause of the occurrence of the abnormality in the transport of the sheet P is the adhesion of the ink to the scale 143 or the scratch on the scale 143.

In a case where the period of the timing at which the change in the transport speed has occurred is the period t1 and the change in the transport speed does not exceed the threshold value TH, the determining section 222 determines that the change is not sudden. In a case where the change is not sudden, the determining section 222 determines that the cause of the abnormality is powder fogging on the scale 143.

As a result, in the system 1, it is possible to identify that the cause of the abnormality in the transport of the sheet P is the powder fogging on the scale 143.

In addition, in a case where the period of the timing at which the change in the transport speed has occurred is the period t2, the determining section 222 determines that the location where the abnormality has occurred is the gear 136.

As a result, in the system 1, it is possible to identify that the location where the abnormality has occurred in the transport of the sheet P is the gear 136.

In a case where the period of the timing at which the change in the transport speed has occurred is the period t2 and the change in the transport speed exceeds the threshold value TH, the determining section 222 determines that the change is sudden. Then, in a case where the change is sudden, the determining section 222 determines that the cause of the abnormality is tooth chipping of the gear 136.

As a result, in the system 1, it is possible to identify that the cause of the abnormality in the transport of the sheet P is the tooth chipping of the gear 136.

In a case where the period of the timing at which the change in the transport speed has occurred is the period t2 and the change in the transport speed does not exceed the threshold value TH, the determining section 222 determines that the change is not sudden. In a case where the change is not sudden, the determining section 222 determines that the cause of the abnormality is wear of the gear 136.

As a result, in the system 1, it is possible to identify that the cause of the abnormality in the transport of the sheet P is the wear of the gear 136.

In a case where the period of the timing at which the change in the transport speed has occurred is the transport period t3 corresponding to the distances between the predetermined transport position of the sheet P and the transport rollers 131m and 131n, the determining section 222 determines that the location where the abnormality has occurred is the transport rollers 131m and 131n.

As a result, in the system 1, it is possible to identify that the location where the abnormality has occurred in the transport of the sheet P is the transport rollers 131m and 131n.

In addition, in a case where the timing at which the change in the transport speed has occurred corresponds to the transport period t3 and the change in the transport speed exceeds the threshold value TH, the determining section 222 determines that the change is sudden. Then, in a case where the change is sudden, the determining section 222 determines that the cause of the abnormality is a sudden change in the load of the transport rollers 131m and 131n.

As a result, in the system 1, it is possible to identify that the cause of the occurrence of the abnormality in the transport of the sheet P is the sudden change in the load of the transport rollers 131m and 131n.

In addition, the server apparatus 200 includes the correcting section 224 that corrects the timing of printing on the sheet P in the printing section 121. In a case where the determining section 222 determines that the cause of the abnormality is the sudden change in the load of the transport rollers 131m and 131n, the correcting section 224 corrects the timing of the printing based on the amount of change in the transport speed calculated by performing statistical processing on a value detected by the encoder 142.

As a result, in the system 1, it is possible to perform the printing on the sheet P according to the sudden change in the load of the transport rollers 131m and 131n.

In addition, in a case where the timing at which the change in the transport speed has occurred corresponds to the transport period t3 and the change in the transport speed does not exceed the threshold value TH, the determining section 222 determines that the change is not sudden. In a case where the change is not sudden, the determining section 222 determines that the cause of the abnormality is a change in the transport rollers 131m and 131n over time.

As a result, in the system 1, it is possible to identify that the cause of the abnormality in the transport of the sheet P is the change in the transport rollers 131m and 131n over time.

In a case where the change in the transport speed is not sudden, the correcting section 224 performs the PTS correction based on a statistic of the value detected by the encoder 142.

As a result, in the system 1, it is possible to perform the printing on the sheet P according to the change in the transport speed.

In addition, the server apparatus 200 further includes the notifying section 223 that notifies a message corresponding to the location where the abnormality has occurred and that has been determined by the determining section 222.

As a result, a user of the system 1 can easily confirm the location where the abnormality has occurred, and can appropriately handle the abnormality.

The embodiment described above is a preferred embodiment of the present disclosure. However, the present disclosure is not limited to this embodiment, and various modifications can be made without departing from the scope of the present disclosure.

Each of the functional sections of the control section 201 illustrated in FIG. 4 has a functional configuration implemented by cooperation of hardware and software, and a specific implementation form of each of the functional sections is not particularly limited. Therefore, hardware individually corresponding to each of the functional sections may not be mounted, and it is also possible to adopt a configuration in which one processor 220 executes the program 211 to implement the functions of the plurality of functional sections. Further, some of the functions implemented by the software in the above-described embodiment may be implemented by hardware, and some of the functions implemented by the hardware may be implemented by software.

Further, for example, in the control section 201 illustrated in FIG. 3, at least one of the acquiring section 221, the determining section 222, the notifying section 223, and the correcting section 224 may be constituted by an integrated circuit or another digital circuit. In addition, at least one of the above-described sections may include an analog circuit. The integrated circuit includes at least one of an LSI, an ASIC, and a PLD. The PLD includes, for example, an FPGA. Each of the sections may be a combination of the processor 220 and an integrated circuit. The combination is referred to as, for example, an MCU, an SoC, a system LSI, or a chip set.

In addition, the program 211 executed by the processor 220 in order to implement the above-described diagnosis method may be stored in a storage medium readable by the processor 220 and may be provided. The storage medium readable by the processor 220 may be an optical storage medium such as a DVD, a semiconductor memory device such as a USB memory or an SSD, or the like. Further, the program 211 may be stored in a computer coupled to a network such as the Internet, and may be downloaded via the network and provided or distributed in the form of a transmission medium.

In addition, the process in the flowchart illustrated in FIGS. 7A and 7B is divided into the processing units in accordance with the main content of the process in order to facilitate understanding of the process of the processor 220, and the present disclosure is not limited by the method for dividing the process into the processing units illustrated in the flowchart of FIGS. 7A and 7B or the names of the processing units. In addition, the process of the processor 220 may be divided into more processing units in accordance with the content of the process, and may be divided such that one processing unit includes more processes. In addition, the order of the process in the above-described flowchart is not limited to the illustrated example.

In the above-described embodiment, the server apparatus 200 is described as an example of the diagnosis apparatus, but the diagnosis apparatus may be the control device 110 of the printer 100 or the terminal apparatus 300. For example, the control device 110 of the printer 100 or a processor of the terminal apparatus 300 may execute the program 211. As a result, the control device 110 of the printer 100 or the processor of the terminal apparatus 300 can function as the acquiring section 221, the determining section 222, the notifying section 223, and the correcting section 224.

Further, the drive components to be subjected to the abnormality determination are not limited to the gear 136 and the transport rollers 131m and 131n described above. For example, an abnormality in the motor 135 may be identified based on a change in the transport speed that occurs at a timing synchronized with the rotation of the motor 135.

### Summary of Present Disclosure

A summary of the present disclosure will be described below.

### Supplementary Note 1

A diagnosis apparatus including: an acquiring section that acquires a transport speed of a medium in a transport apparatus that transports the medium to a printing section; a storage section that stores the acquired transport speed; and a determining section that performs time-series analysis on the stored transport speed and determines, based on a timing at which a change in the transport speed has occurred, a location where an abnormality has occurred in the transport of the medium.

Accordingly, it is not necessary to form an image on the medium, read the formed image, or the like in order to perform failure diagnosis, and it is possible to easily perform the failure diagnosis.

### Supplementary Note 2

The diagnosis apparatus according to Supplementary Note 1, wherein the determining section determines, based on a period of the timing at which the change in the transport speed has occurred, the location where the abnormality has occurred in the transport of the medium.

Accordingly, it is possible to identify the location where the abnormality has occurred in the transport of the medium, based on the period of the timing at which the change in the transport speed has occurred.

### Supplementary Note 3

The diagnosis apparatus according to Supplementary Note 2, wherein the determining section determines the occurrence of the abnormality in a second drive component that is driven together with a first drive component to be subjected to detection by a sensor for the acquisition of the transport speed of the medium and that is disposed for the transport of the medium.

Accordingly, it is possible to identify the occurrence of the abnormality in the second drive component that is driven together with the first drive component to be subjected to detection by the sensor and that is disposed for the transport of the medium.

### Supplementary Note 4

The diagnosis apparatus according to Supplementary Note 3, wherein the sensor detects, based on a scale disposed in a transport roller, rotation of the transport roller that transports the medium, and the determining section determines that the location where the abnormality has occurred is the scale in a case where the period of the timing at which the change in the transport speed has occurred is a first period corresponding to an interval of the scale.

Accordingly, it is possible to identify that the location where the abnormality has occurred in the transport of the medium is the scale disposed in the transport roller.

### Supplementary Note 5

The diagnosis apparatus according to Supplementary Note 4, wherein the determining section determines that a cause of the abnormality is adhesion of ink to the scale or a scratch on the scale in a case where the period of the timing at which the change in the transport speed has occurred is the first period and the change in the transport speed exceeds a predetermined threshold value.

Accordingly, it is possible to identify that the cause of the abnormality in the transport of the medium is the adhesion of the ink to the scale disposed in the transport roller or the scratch on the scale.

### Supplementary Note 6

The diagnosis apparatus according to Supplementary Note 4 or 5, wherein the determining section determines that a cause of the abnormality is powder fogging on the scale in a case where the period of the timing at which the change in the transport speed has occurred is the first period and the change in the transport speed does not exceed a predetermined threshold value.

Accordingly, it is possible to identify that the cause of the abnormality in the transport of the medium is the powder fogging on the scale disposed in the transport roller.

### Supplementary Note 7

The diagnosis apparatus according to any one of Supplementary Notes 4 to 6, wherein the transport apparatus includes a gear that transmits a driving force of a motor to the transport roller, and the determining section determines that the location where the abnormality has occurred is the gear in a case where the period of the timing at which the change in the transport speed has occurred is a second period corresponding to a rotation period of the gear.

Accordingly, it is possible to identify that the location where the abnormality has occurred in the transport of the medium is the gear that transmits the driving force of the motor to the transport roller.

### Supplementary Note 8

The diagnosis apparatus according to Supplementary Note 7, wherein the determining section determines that a cause of the abnormality is tooth chipping of the gear in a case where the period of the timing at which the change in the transport speed has occurred is the second period and the change in the transport speed exceeds a predetermined threshold value.

Accordingly, it is possible to identify that the cause of the abnormality in the transport of the medium is the tooth chipping of the gear that transmits the driving force of the motor to the transport roller.

### Supplementary Note 9

The diagnosis apparatus according to Supplementary Note 7 or 8, wherein the determining section determines that a cause of the abnormality is wear of the gear in a case where the period of the timing at which the change in the transport speed has occurred is the second period and the change in the transport speed does not exceed a predetermined threshold value.

Accordingly, it is possible to identify that the cause of the occurrence of the abnormality in the transport of the medium is the wear of the gear that transmits the driving force of the motor to the transport roller.

### Supplementary Note 10

The diagnosis apparatus according to any one of Supplementary Notes 4 to 9, wherein the determining section determines that the location where the abnormality has occurred is the transport roller in a case where the period of the timing at which the change in the transport speed has occurred is a third period corresponding to a distance between a predetermined transport position of the medium and the transport roller.

Accordingly, it is possible to identify that the location where the abnormality has occurred in the transport of the medium is the transport roller.

### Supplementary Note 11

The diagnosis apparatus according to Supplementary Note 10, wherein the determining section determines that a cause of the abnormality is a sudden change in a load of the transport roller in a case where the period of the timing at which the change in the transport speed has occurred is the third period and the change in the transport speed exceeds a predetermined threshold value.

Accordingly, it is possible to identify that the cause of the abnormality in the transport of the medium is the sudden change in the load of the transport roller.

### Supplementary Note 12

The diagnosis apparatus according to Supplementary Note 11, further including a correcting section that corrects a timing of printing on the medium in the printing section based on an amount of change in the transport speed calculated by performing statistical processing on a value detected by the sensor in a case where the determining section determines that the cause of the abnormality is the sudden change in the load of the transport roller.

Accordingly, it is possible to perform the printing on the medium according to the sudden change in the load of the transport roller.

### Supplementary Note 13

The diagnosis apparatus according to any one of Supplementary Notes 10 to 12, wherein the determining section determines that a cause of the abnormality is a change in the transport roller over time in a case where the period of the timing at which the change in the transport speed has occurred is the third period and the change in the transport speed does not exceed a predetermined threshold value.

Accordingly, it is possible to identify that the cause of the abnormality in the transport of the medium is the change in the transport roller over time.

### Supplementary Note 14

The diagnosis apparatus according to any one of Supplementary Notes 6, 9, and 13, further including a correcting section that corrects a timing of printing on the medium in the printing section based on a statistic of a value detected by the sensor in a case where the change in the transport speed does not exceed the predetermined threshold value.

Accordingly, in a case where the change in the transport speed does not exceed the predetermined threshold value, it is possible to perform the printing on the medium according to the change in the transport speed.

### Supplementary Note 15

The diagnosis apparatus according to any one of Supplementary Notes 1 to 14, further including a notifying section that notifies a message corresponding to the location that has been determined by the determining section and where the abnormality has occurred.

Accordingly, a user can easily confirm the location where the abnormality has occurred, and can appropriately handle the abnormality.

### Supplementary Note 16

A system in which a transport apparatus that transports a medium to a printing section and a diagnosis apparatus are communicably coupled to each other via a network, wherein the diagnosis apparatus includes an acquiring section that acquires a transport speed of the medium in the transport apparatus that transports the medium to the printing section, a storage section that stores the acquired transport speed, and a determining section that performs time-series analysis on the stored transport speed and determines, based on a timing at which a change in the transport speed has occurred, a location where an abnormality has occurred in the transport of the medium.

Accordingly, it is not necessary to form an image on the medium, read the formed image, or the like in order to perform failure diagnosis, and it is possible to easily perform the failure diagnosis.

### Supplementary Note 17

A diagnosis method including causing a computer to execute processing of: acquiring a transport speed of a medium in a transport apparatus that transports the medium to a printing section, storing the acquired transport speed in a storage section, and performing time-series analysis on the stored transport speed, and determining, based on a timing at which a change in the transport speed has occurred, a location where an abnormality has occurred in the transport of the medium.

Accordingly, it is not necessary to form an image on the medium, read the formed image, or the like in order to perform failure diagnosis, and it is possible to easily perform the failure diagnosis.

What is claimed is:

1. A diagnosis apparatus comprising:
an acquiring section that acquires a transport speed of a medium in a transport apparatus that transports the medium to a printing section;
a storage section that stores the acquired transport speed; and
a determining section that performs time-series analysis on the stored transport speed and determines, based on a timing at which a change in the transport speed has occurred, a location where an abnormality has occurred in the transport of the medium.

2. The diagnosis apparatus according to claim 1, wherein
the determining section determines, based on a period of the timing at which the change in the transport speed has occurred, the location where the abnormality has occurred in the transport of the medium.

3. The diagnosis apparatus according to claim 2, wherein
the determining section determines the occurrence of the abnormality in a second drive component that is driven together with a first drive component to be subjected to detection by a sensor for the acquisition of the transport speed of the medium and that is disposed for the transport of the medium.

4. The diagnosis apparatus according to claim 3, wherein
the sensor detects, based on a scale disposed in a transport roller, rotation of the transport roller that transports the medium, and
the determining section determines that the location where the abnormality has occurred is the scale in a case where the period of the timing at which the change in the transport speed has occurred is a first period corresponding to an interval of the scale.

5. The diagnosis apparatus according to claim 4, wherein
the determining section determines that a cause of the abnormality is adhesion of ink to the scale or a scratch on the scale in a case where the period of the timing at which the change in the transport speed has occurred is the first period and the change in the transport speed exceeds a predetermined threshold value.

6. The diagnosis apparatus according to claim 4, wherein
the determining section determines that a cause of the abnormality is powder fogging on the scale in a case where the period of the timing at which the change in the transport speed has occurred is the first period and the change in the transport speed does not exceed a predetermined threshold value.

7. The diagnosis apparatus according to claim 4, wherein
the transport apparatus includes a gear that transmits a driving force of a motor to the transport roller, and
the determining section determines that the location where the abnormality has occurred is the gear in a case where the period of the timing at which the change in the transport speed has occurred is a second period corresponding to a rotation period of the gear.

8. The diagnosis apparatus according to claim 7, wherein
the determining section determines that a cause of the abnormality is tooth chipping of the gear in a case where the period of the timing at which the change in the transport speed has occurred is the second period and the change in the transport speed exceeds a predetermined threshold value.

9. The diagnosis apparatus according to claim 7, wherein
the determining section determines that a cause of the abnormality is wear of the gear in a case where the period of the timing at which the change in the transport speed has occurred is the second period and the change in the transport speed does not exceed a predetermined threshold value.

10. The diagnosis apparatus according to claim 4, wherein
the determining section determines that the location where the abnormality has occurred is the transport roller in a case where the period of the timing at which the change in the transport speed has occurred is a third period corresponding to a distance between a predetermined transport position of the medium and the transport roller.

11. The diagnosis apparatus according to claim 10, wherein
the determining section determines that a cause of the abnormality is a sudden change in a load of the transport roller in a case where the period of the timing at which the change in the transport speed has occurred is the third period and the change in the transport speed exceeds a predetermined threshold value.

12. The diagnosis apparatus according to claim 11, further comprising
a correcting section that corrects a timing of printing on the medium in the printing section based on an amount of change in the transport speed calculated by performing statistical processing on a value detected by the sensor in a case where the determining section determines that the cause of the abnormality is the sudden change in the load of the transport roller.

13. The diagnosis apparatus according to claim 10, wherein
the determining section determines that a cause of the abnormality is a change in the transport roller over time in a case where the period of the timing at which the change in the transport speed has occurred is the third period and the change in the transport speed does not exceed a predetermined threshold value.

14. The diagnosis apparatus according to claim 6, further comprising
a correcting section that corrects a timing of printing on the medium in the printing section based on a statistic of a value detected by the sensor in a case where the change in the transport speed does not exceed the predetermined threshold value.

15. The diagnosis apparatus according to claim 1, further comprising
a notifying section that notifies a message corresponding to the location that has been determined by the determining section and where the abnormality has occurred.

16. A system in which a transport apparatus that transports a medium to a printing section and a diagnosis apparatus are communicably coupled to each other via a network, wherein
the diagnosis apparatus includes
an acquiring section that acquires a transport speed of the medium in the transport apparatus that transports the medium to the printing section,
a storage section that stores the acquired transport speed, and
a determining section that performs time-series analysis on the stored transport speed and determines, based on a timing at which a change in the transport speed has occurred, a location where an abnormality has occurred in the transport of the medium.

17. A diagnosis method comprising causing a computer to execute processing of:
acquiring a transport speed of a medium in a transport apparatus that transports the medium to a printing section;
storing the acquired transport speed in a storage section; and
performing time-series analysis on the stored transport speed and determining, based on a timing at which a change in the transport speed has occurred, a location where an abnormality has occurred in the transport of the medium.
